(19) United States
(12) Patent Application Publication
(10) Pub. No.: US 2025/0333050 A1
(43) Pub. Date: Oct. 30, 2025

(54) PARKING ASSISTANCE SYSTEM AND METHOD FOR OFFERING A PARKING ASSISTANCE MODE BY MEANS OF A PARKING ASSISTANCE SYSTEM

(71) Applicant: Ford Global Technologies, LLC, Dearborn, MI (US)

(72) Inventors: Markus Krekel, Wermelskirchen (DE); Andreas Giersiefer, Leverkusen (DE)

(73) Assignee: Ford Global Technologies, LLC, Dearborn, MI (US)

(21) Appl. No.: 19/175,398

(22) Filed: Apr. 10, 2025

(30) Foreign Application Priority Data
Apr. 29, 2024 (DE) 102024112037.1

(51) Int. Cl. B60W 30/06

(52) U.S. Cl. CPC B60W 30/06; B60W 2420/403; B60W 2420/408

(57) ABSTRACT

The present disclosure relates to a parking assistance system designed to enhance the ease of parking for vehicles. The system offers at least two parking assistance modes and comprises a parking assistance app, means for determining the state of the vehicle, and means for recognizing the environment of the vehicle, including the availability and location of parking spaces relative to the vehicle. A control unit selects a parking assistance mode based on the state of the vehicle and the recognized environment, and offers the selected mode to the user via the parking assistance app.

### CROSS-REFERENCE TO RELATED APPLICATIONS

The present application claims priority to and the benefit of German Application No. 102024112037.1, filed on Apr. 29, 2024, which is hereby incorporated by reference herein in its entirety.

### FIELD

The present disclosure relates to a parking assistance system having at least two parking assistance modes and to a vehicle having such a parking assistance system. In addition, the disclosure relates to a method of offering a parking assistance mode from at least two parking assistance modes by means of a parking assistance system.

### BACKGROUND

Over the course of time, various technologies have been developed to make parking easier and less stressful. One such technology is that of parking assistance systems, which allow drivers to automate the parking process, although automated parking may also be affected without the driver having to be present in the vehicle.

Parking assistance systems may identify suitable parking spaces such as, for example, parallel parking slots, perpendicular parking spaces in front of or behind the vehicle, or parking spaces in garages, and then take over control of the steering wheel to steer the car autonomously into the identified parking slot. During this process, the driver continues to operate the accelerator and brake pedals and, if there is not an automatic transmission, shift the gears. Although the steering is affected automatically, the driver thus remains responsible for the safe parking of the car. In the case of autonomous vehicles, the driver does not even need to operate the accelerator and brake pedals or shift the gears. Such a parking assistance system may therefore also be realized as a remotely controllable parking assistance system (RePA, Remote Park Assistant), which can be used to park or unpark a vehicle or to adapt the parking position remotely by means of an app on a smartphone, tablet or other mobile device.

Particularly in the case of self-driving vehicles, the parking assistance system may generally provide at least two parking assistance modes, namely an “autonomous parking position adjustment” mode (Remote Park Assist Adjust), which only enables the vehicle to maneuver forwards and backwards autonomously, in which, if necessary, small steering movements are also performed so that the vehicle does not come too close to obstacles at the side, and an “autonomous parking assistant” mode (Full Remote Park Assist), in which fully autonomous parking of the vehicle in any parking space may be initiated. In other words, a remotely controllable parking assistance system may be designed to park or unpark the vehicle or to adjust the parking position when the user is outside of the vehicle. For this purpose, the vehicle's remotely controllable parking assistance system communicates with an app on a mobile device, for instance a smartphone or tablet, via which an autonomous parking maneuver may be initiated.

Even if the existing parking assistance systems already provide a certain degree of ease of use when parking, there is a requirement to further increase ease of use, in particular in the case of remotely controllable parking assistance systems. The disclosure is therefore based on an object of providing a parking assistance system, and a method for offering a parking assistance mode by means of a parking assistance system that further increases ease of use.

An object is achieved by a parking assistance system according to claim 1, and by a method for offering a parking assistance mode by means of a parking assistance system according to claim 7. Some of the advantageous developments of the disclosure are given in the dependent claims.

### SUMMARY

The embodiments described below, and in particular any “preferred” embodiments, are possible examples of implementations, and are set forth merely to provide a clear understanding of the principles of the disclosure. Many variations and modifications may be made to the embodiment(s) described below without substantially deviating from the spirit and principles of the techniques described herein. All modifications are intended to be included herein within the scope of this disclosure and protected by the appended claims.

In one embodiment of the parking assistance system, it has at least two parking assistance modes for a vehicle and may comprise:
parking assistance app;
   means for determining the state of the vehicle;
   means for recognizing the environment of the vehicle, including the availability and location of parking spaces relative to the vehicle;
   a control unit configured to select a parking assistance mode from the parking assistance modes, on the basis of the state of the vehicle and the recognized environment, and via the parking assistant app to offer for use the selected parking assistance mode to a user of the parking assistance system.

Since the parking assistance system automatically selects the appropriate parking assistance mode from the available parking assistance modes on the basis of the state of the vehicle and the recognized environment, and then offers the selected parking assistance mode, the number of interactions between the user and the parking assistance system is reduced, thereby enhancing ease of use. In particular, the parking assistance app may include a visual display that shows the selected parking mode, and may additionally show the state of the vehicle and/or items of information relating to the environment, etc. On the other hand, it is also possible for the user interface to use acoustic signals to inform the user of the selected parking assistance mode.

According to a further embodiment of the parking assistance system, the means for determining the state of the vehicle comprise sensors that sense the operating state of the vehicle, in particular whether the vehicle is switched on or switched off. But it may also be sensed, for example, whether the vehicle, when switched on, is stationary or moving. By determining the vehicle state as comprehensively and accurately as possible, safety risks may be minimized, for example by preventing the parking assistance system from being activated when the vehicle is in an unsuitable state.

The means for recognizing the environment of the vehicle may comprise at least one of the following means: at least one ultrasonic sensor, at least one camera, at least one radar unit, at least one LiDAR unit. In some examples, the means for recognizing the environment are attached to the outer peripheral surfaces of the vehicle. The means for recognizing the environment recognizes elements located within a defined distance of the vehicle. In some examples, the sensing range of the means for recognizing the environment covers one or more regions around the vehicle. In some examples, the sensing range of the means for recognizing the environment covers all regions located within an angle of 360 degrees around the vehicle. The means for recognizing the environment are electronically connected to an electronic control device, in order to transmit sensed signals to the control device.

In a further embodiment of the disclosure, the control unit is furthermore configured such that the selecting of the parking assistance mode includes an analysis of position data of the vehicle. The analysis of position data may be effected, for example, using map data and GPS data or other geodata. This makes it possible, for example, to store preferences for certain positions, for instance for the “home position”, these preferences taking effect when the corresponding position is recognized on the basis of the analysis of position data.

In a further embodiment of the disclosure, the control unit is furthermore configured such that it offers a Remote Park Assist Adjust when the vehicle is not switched on. In many cases in which the vehicle is not switched on, the vehicle is in a parked state, such that Full Remote Park Assist is not required. However, Remote Park Assist Adjust may be helpful, for example, if the vehicle is to be moved slightly away from a wall situated behind the vehicle, in order to allow better access to the boot.

In a further embodiment of the disclosure, the control unit is configured such that the selecting of the parking assistance mode includes an analysis of the location of available parking spaces, thereby enabling the vehicle to be parked in the most suitable parking space if there is no preference for a particular parking space, or a particular type of parking space, stored in the parking assistance system.

A further embodiment of the present disclosure provides a method for offering a parking assistance mode by means of a parking assistance system. The method comprises the steps of:
a. determining the state of the vehicle;
b. recognizing the environment of the vehicle, including the availability and location of parking spaces relative to the vehicle;
c. selecting a parking assistance mode from the parking assistance modes, on the basis of the state of the vehicle and the recognized environment, and
d. offering or presenting the selected parking assistance mode on a parking assistance app.

Since the method automatically selects the appropriate parking assistance mode from the available parking assistance modes, and then offers the selected parking assistance mode, the number of interactions between the user and the parking assistance system is reduced, thereby enhancing ease of use. In particular, the parking assistance app may include a visual display that shows the selected parking mode, and may additionally show the state of the vehicle and/or items of information relating to the environment, etc. On the other hand, it is also possible for the user interface to use acoustic signals to inform the user of the selected parking assistance mode.

The step of determining the state of the vehicle may include the sensing of the operating state of the vehicle by means of sensors, as has been described with reference to the parking assistance system according to the disclosure. Additionally or alternatively, the step of recognizing the environment of the vehicle may include the evaluating of image data or radar data.

Provided according to a further embodiment of the disclosure is a computer program, having instructions that, when executed by a processor of a vehicle, cause the vehicle to perform the method for the purpose of controlling a parking assistance system according to the disclosure. The computer program in this case is programmed for a vehicle processor, and may include instructions for establishing communication with a parking assistance app on a smartphone, tablet or other mobile data processing device. The computer program may be stored on a non-volatile memory medium or made available to be called up via a network.

Provided in a further embodiment is a vehicle having a remotely controlled parking assistance system. The vehicle may be a conventional petrol-powered vehicle, a hybrid vehicle, an electric vehicle, a fuel-cell vehicle and/or any other type of vehicle. The vehicle includes parts related to mobility, such as, for example, a power train including an engine, a transmission, a suspension, a drive shaft and/or wheels, etc. The vehicle may be a semi-autonomous vehicle, for example some routine movement functions such as, for example, parking, are controlled by the vehicle. However, it may also be a fully autonomous vehicle, with movement functions being controlled by the vehicle without direct driver intervention. In the example represented, in addition to the means for recognizing the environment of the vehicle, and the control unit of the parking assistance system, the vehicle comprises an on-board communication platform that enables communication with a parking assistance app of the parking assistance system installed on a smartphone, tablet or other mobile data processing device. Additionally, or alternatively, the parking assistance app of the parking assistance system may be installed on an infotainment system of the vehicle.

Embodiments of the disclosure are defined by the appended claims and not by the brief presentation of the disclosure. A broad overview of various aspects of the disclosure is provided here purely to present a selection of concepts, which are described more fully below in the detailed description section. This brief presentation is not intended to identify any key or essential features of the claimed subject-matter, nor is it intended to be used as an isolated aid in determining the scope of protection of the claimed subject-matter.

### BRIEF DESCRIPTION OF THE DRAWINGS

While the disclosure may be embodied in various forms, some exemplary and non-limiting embodiments are represented in the figures and are described below. The present disclosure is to be considered an exemplary representation of the disclosure and is not intended to limit the disclosure to the specific embodiments represented.

Further features and advantages of the disclosure will become apparent from the following description of exemplary embodiments with reference to the drawings, in which:

FIG. 1 shows a flow diagram of a first embodiment of a method for parking a vehicle by use of a parking aid system.

FIG. 2 shows a flow diagram of a second embodiment of a method for parking a vehicle by use of a parking aid system.

FIG. 3 shows a situation in which there is no parking situation.

FIG. 4 shows unparking.

FIG. 5 shows parking in a lateral parking space.

FIG. 6 shows parking in a garage in front of the vehicle.

FIG. 7 shows parking in a garage that constitutes a lateral parking space.

FIG. 8 shows parking in a garage in front of the vehicle.

FIG. 9 shows a vehicle having a parking assistance system.

### DETAILED DESCRIPTION

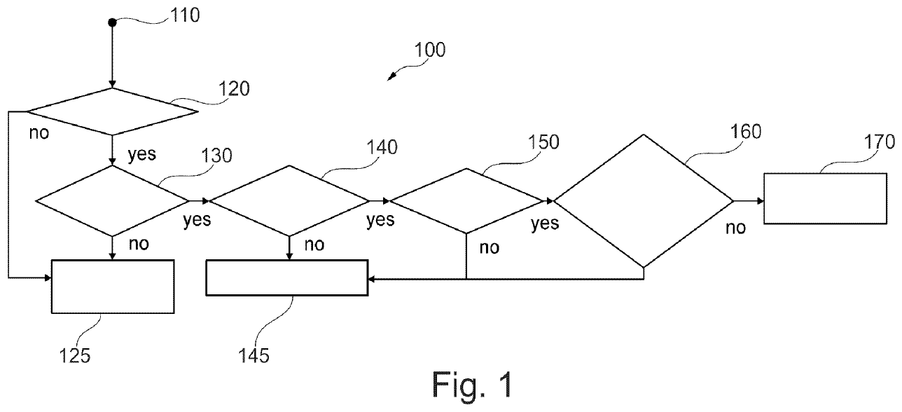

FIG. 1 shows a flow diagram illustrating a multiplicity of steps of an embodiment of the present disclosure that are performed by means of a parking assistance system. The flow diagram may be viewed as method steps of the method or as instructions of the computer program. These instructions, once executed, perform at least part of the method 100.

As shown in FIG. 1, the method begins with a first step 110, in which the activation of the remote control app for the parking assistant (RePA app) is represented. The remote control app in this case may receive an activation signal (ON signal) from a driver or another occupant. The remote control app is preferably launched by a mobile data processing unit, which may be, for example, a smartphone or a tablet. In some cases, however, the remote control app may also be launched by an infotainment unit (not shown here) contained in the vehicle.

A query as to whether the vehicle is switched on is then effected in step 120. If the vehicle is not switched on, this usually means that the vehicle is parked. The method then proceeds to step 125, in which the Remote Park Assist Adjust mode appears. The Remote Park Assist Adjust mode only allows the vehicle to maneuver autonomously forwards and backwards, with small steering movements also being executed as required to prevent the vehicle from coming too close to obstacles at the side. In the Remote Park Assist Adjust mode, the vehicle can then be started, in order to maneuver it forwards or backwards. One example of use is moving the vehicle forwards, for example to move it far enough away from a wall situated at the rear, to allow easy access to the boot. Another example is moving a vehicle forwards or backwards to make it easier to enter the vehicle, for instance by moving the vehicle away from a puddle in the area of the vehicle doors. Yet another example is the unparking of a parked vehicle, with the vehicle being moved far enough in a straight line out of the parking space to make it easy to enter the vehicle.

If it is established in step 120 that the vehicle is switched on, it is checked in step 130 whether there is a parking space (lateral parking space) available to the side of the vehicle. If no lateral parking space is available, the method proceeds to step 125, in which the Remote Park Assist Adjust mode is displayed. If no free lateral parking space is available, remote-controlled forward and backward maneuvering of the vehicle is sufficient.

However, if there is a free lateral parking space, it is checked in the next step 140 whether a parking space is also available in front of the vehicle. If this is not the case, the method switches in step 145 to the Full Remote Park Assist mode, in which fully autonomous parking of the vehicle in the lateral parking space may be initiated. If, on the other hand, there is a free parking space in front of the vehicle, it is then checked in step 150 whether the vehicle is at a known location. This check may be affected, for example, on the basis of maps and position data. If the location is unknown, the method switches in step 145 to the Full Remote Park Assist mode, in which fully autonomous parking in the parking space in front of the vehicle or in the lateral parking space is possible. The user of the parking assistance app can therefore choose between the lateral parking space and the parking space in front of the vehicle. If, on the other hand, the location is known, it is checked in step 160 whether a lateral parking space is preferred for the location. Should a lateral parking space at the location be preferred, the method goes in step 145 into the Full Remote Park Assist mode, with the aid of which the vehicle may be parked autonomously in the lateral parking space at the location. If, on the other hand, a lateral parking space is not preferred, in step 170 the Remote Park Assist Adjust mode is offered, with the aid of which the vehicle may be parked by driving forwards into the parking space in front of the vehicle.

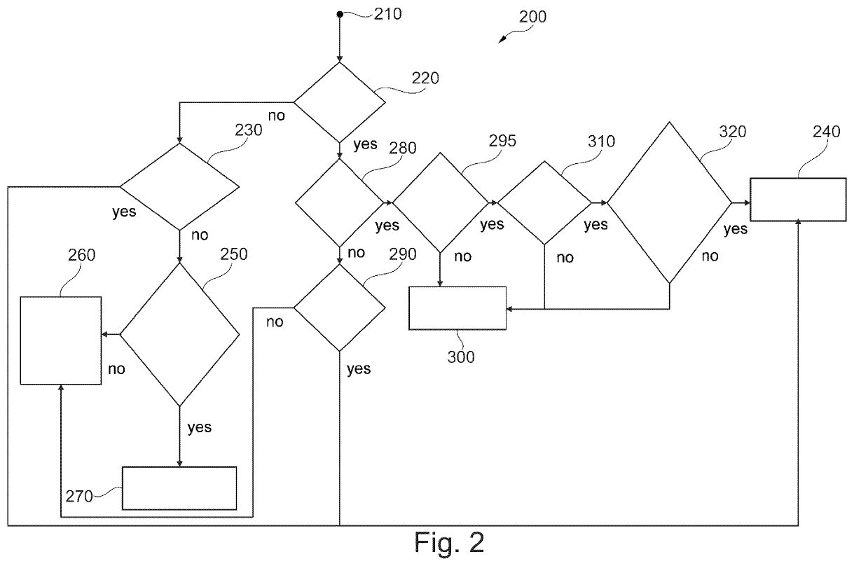

FIG. 2, likewise, shows a flow diagram, which shows various steps according to a second embodiment of the present disclosure that are performed with the aid of a parking assistance system. The flow diagram may be viewed as method steps of the method or as instructions of the computer program. These instructions, once executed, perform at least part of the method.

As shown in FIG. 2, the method 200 begins with a first step 210, in which the activating of the remote control app for the parking assistant (RePA app) is represented.

A query as to whether the vehicle is switched on is then effected in step 220. If the vehicle is not switched on, this usually means that the vehicle is parked. The method then proceeds to step 230, in which it is checked whether the garage is in front. If this is the case, the maneuver “park to the front” may be executed in step 240 using Remote Park Assist Adjust. If the garage is not located in front, step 250 is executed and the parking situation is checked. This check may include checking whether there are vehicles present to the left and/or right of the vehicle. If there is no vehicle present to the left and/or right, step 260 is executed, in which the Remote Park Assist Adjust mode is offered, in which only autonomous forward and backward maneuvering of the vehicle is possible. If it is established in step 250 that there are vehicles present to the left and/or right, a “straight-ahead unparking” maneuver may be performed in step 270 using Remote Park Assist Adjust.

If it is established in step 220 that the vehicle is switched on, it is checked in step 280 whether there is a free lateral parking space. If this is not the case, it is checked in step 290 whether there is a free parking space in front of the vehicle. If there is also no free parking in front of the vehicle, the method proceeds with step 260. If, on the other hand, there is a free parking space in front of the vehicle, step 240 is executed, in which the Remote Park Assist Adjust is offered, by means of which the vehicle may be maneuvered forwards and backwards, and parked forwards.

If it is established in step 280 that there is a free lateral parking space, it is checked in step 299 whether there is also a free parking space in front of the vehicle. If not, in step 300 the Full Remote Park Assist mode is offered, by means of which autonomous lateral parking the vehicle may be effected. If, on the other hand, it is established in step 295 that there is also a parking space in front of the vehicle in addition to the lateral parking space, it is checked in step 310 whether the current location of the vehicle is known. If the current location is not known, in step 300 the Full Remote Park Assist mode is offered, by means of which the vehicle may be parked autonomously in the lateral parking space or in the parking space in front of the vehicle. If, on the other hand, it is established in step 310 that the current location is known, step 320 is executed, in which it is checked whether a lateral parking space is preferred at the recognized location. If this is the case, in step 300 the Full Remote Park Assist mode is offered, by means of which autonomous lateral parking of the vehicle may be effected. If, on the other hand, no lateral parking space is preferred for the location, step 240 is executed, in which Remote Park Assist Adjust is offered, by means of which the vehicle may be maneuvered forwards and backwards, and parked forwards.

In summary, the methods 100, 200 represented in FIG. 1 and FIG. 2 provide a detailed description of the steps that enable automatic preselection from the “Remote Park Assist Adjust” and “Full Remote Park Assist” modes in order to offer a user of the parking assistance system the most suitable mode in the current situation. The preselection in this case is automatically assisted by an analysis of the vehicle state and of the environment, in consideration of the availability of parking spaces and, if necessary, with the addition of position data.

Remote Park Assist Adjust allows the vehicle to be maneuvered forwards and backwards, with only small steering movements being effected in order to increase the distance from obstacles at the side. Full Remote Park Assist, on the other hand, provides for complex parking scenarios with steering movements of any magnitude. An advantage of the present disclosure is that the selection steps to be performed by the user are reduced by the automated preselection.

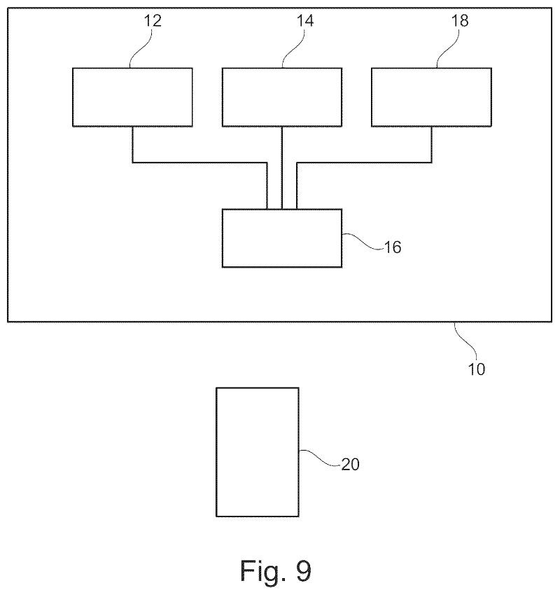

A vehicle 10 having a parking assistance system that is suitable for performing the methods described with reference to FIGS. 1 and 2 is represented schematically in FIG. 9, in the form of a block diagram. The vehicle 10 comprises a means for determining the state 12 of the vehicle 10, a means for recognizing the environment 14 of the vehicle 10, and a control unit 16. In addition, the parking assistance system in the present example comprises a communication unit 18, by means of which it can communicate with a smartphone 20 on which a parking assistance app is installed, or with another mobile data processing device on which the parking assistance app is installed. In addition, the communication unit 18 in the present example comprises a GPS module for receiving position data relating to the vehicle 10.

The means for determining the state 12 of the vehicle 10 may comprise one or more sensors, by means of which, or with the aid of which, the state of the vehicle may be interrogated. This sensor or these sensors may be located, in particular, in the switch-on device of the vehicle 10, in the engine control unit of the vehicle 10 or in the drive train of the vehicle 10.

The means for recognizing the environment 14 may comprise, in particular, at least one ultrasonic sensor, at least one camera, at least one radar unit, at least one LiDAR unit, etc. The means for recognizing the environment 14 of the vehicle 10 preferably effect recognition in 360° around the vehicle 10 over a range of a plurality of meters, in particular at least 10 meters, preferably at least 20 meters. The means for recognizing the environment 14of the vehicle 10 are in particular also suitable for sensing the availability and position of parking spaces relative to the vehicle 10.

The means for determining the state 12 of the vehicle 10, the means for recognizing the environment 14 of the vehicle 10 and the communication unit 18 are connected to the control unit 16. The latter receives signals from the means for determining the state 12 of the vehicle 10 and the means for recognizing the environment 14 of the vehicle 10, which signals represent the sensed state of the vehicle 10 and the sensed environment of the vehicle 10, including the availability and position of parking spaces relative to the vehicle 10. In addition, the control unit 16 may receive position data relating to the vehicle 10 via the communication module 18. The control unit 16 is designed to ascertain the appropriate parking assistance mode, on the basis of the received signals and data, and to transmit it by means of the communication module 18 to the parking assistance app installed on the smartphone 20.

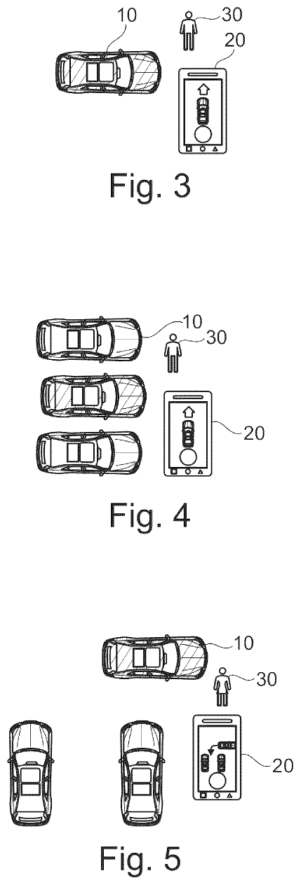

Shown in the following, with reference to FIGS. 3 to 8, are various situations and the decisions that are made based on the steps shown in the flow diagram of FIG. 2.

FIG. 3 shows a first scenario in which a parking situation does not exist. At the beginning of the scenario, the vehicle 10 is switched off and there is also no parking situation, i.e. there is neither a lateral parking space nor a parking space in front of the vehicle. This situation constitutes the starting point for activation of the parking assistance system. In this example, as also in the following examples, activation and the actions subsequently performed by the user are effected by means of a parking assistance app installed on a smartphone 20. Instead of being installed on a smartphone, the parking assistance app may also be installed on another mobile device, for instance a tablet. However, activation and the actions subsequently performed by the user may also be performed from the vehicle, in which case, for example, the parking assistance app is then provided, for example, on the vehicle's infotainment system.

Since, in the scenario represented in FIG. 3, the vehicle 10 is switched off and there is also no parking situation, the flow diagram of FIG. 2 leads to step 260, in which the “Remote Park Assist Adjust” mode is offered on the parking assistance app, this mode only allowing the vehicle to be maneuvered forwards and backwards.

The graphical representation may include additional elements that provide the user 30 with additional visual items of information such as, for example, icons representing the switched-off state of the vehicle 10, the launching of the parking assistance system, or absence of a parking situation. These visual items of information can assist the user 30 in understanding the current status and available actions.

FIG. 4 shows the unparking of a vehicle by driving forwards using the parking assistance system. This illustration assumes that the vehicle 10 is switched off and that the parking assistance system has been activated by means of the parking assistance app installed on the smartphone 20. In this situation, the flow diagram of FIG. 2 leads to step 270, in which a maneuver “unparking by driving straight ahead” may be performed using the Remote Park Assist Adjust. The direction of unparking is indicated on the smartphone display by arrows, and an interface or notification signals to the driver/user 30 that unparking is available by means of the Remote Park Assist Adjust.

FIG. 5 shows the lateral parking of a vehicle using the parking assistance system. The situation represented in FIG. 5 assumes that the vehicle 10 is switched on when the parking assistance system is launched by means of the parking assistance app installed on the smartphone 20. In this illustration, a parking space to the side of the vehicle 10, i.e. a lateral parking space, is recognized. However, there is no parking space in front of the vehicle. In this situation, the flow diagram of FIG. 2 leads to step 300, in which Full Remote Park Assist is offered, by means of which the user may then initiate parking in the lateral parking space.

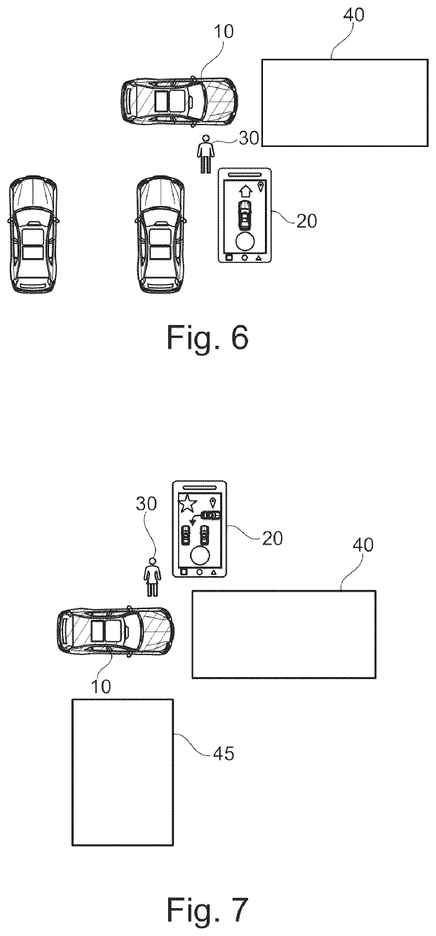

FIG. 6 shows a maneuver for parking in a garage 40, which in this example constitutes a parking space in front of the vehicle, using the parking assistance system. The situation represented in FIG. 6 assumes that the vehicle 10 is switched on when the parking assistance system is launched by means of the parking assistance app installed on the smartphone 20. In this situation, a parking space to the side of the vehicle 10, i.e. a lateral parking space, is recognized. A parking space in front of the vehicle, namely the parking space in the garage 40, is also recognized. In addition, the current location is recognized, which in this example is the location “at home” (home position), for which, in this example, there is no stored preference for lateral parking. In this situation, the flow diagram of FIG. 2 leads to step 240, in which a maneuver “park by driving straight ahead” may be performed using the Remote Park Assist Adjust in order to park the vehicle in the garage 40.

FIG. 7 shows a maneuver for parking in a garage 45, which in this example constitutes a lateral parking space, with the aid of the parking assistance system. There is also a second garage 40, which in this example constitutes parking space in front of the vehicle 10. The situation shown in FIG. 7 assumes that the vehicle 10 is switched on when the parking assistance system is launched by means of the parking assistance app installed on the smartphone 20. In this situation, a lateral parking space is recognized, namely the parking space in the garage 45. In addition, a parking space in front of the vehicle is recognized, namely the parking space in the garage 40. The current location is also recognized, which in this example is the “at home” location (home position), for which, in this example, there is a stored preference for lateral parking. In this situation, the flow diagram of FIG. 2 leads to step 300, in which Full Remote Park Assist is offered, by means of which the user may then park the vehicle 10 in the lateral parking space, namely in the garage 45.

The preference for lateral parking, and the fact that the current location has been recognized, are signaled on the smartphone display by means of icons in order to assist the user in understanding the current status and the preselected mode.

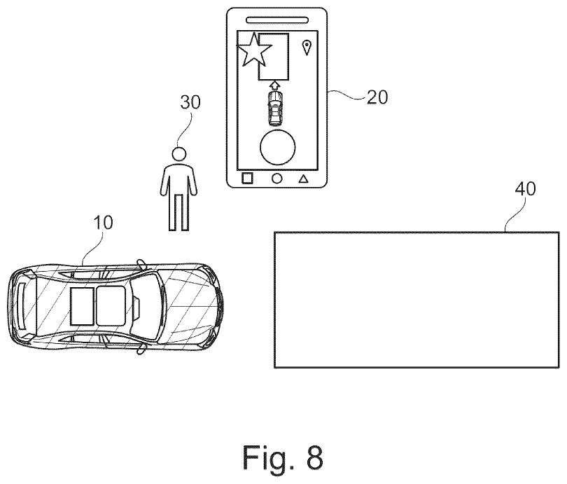

FIG. 8 shows a maneuver for parking in a front parking space using the parking assistance system. The situation represented in FIG. 8 assumes that the vehicle 10 is switched on when the parking assistance system is launched by means of the parking assistance app installed on the smartphone 20. In this situation, a parking space in front of the vehicle is recognized, namely the parking space in the garage 40. Also recognized is the current location, which in this example is the location “at home” (home position). In the example shown in FIG. 8, there is no preference stored for this location. In this situation, the flow diagram of FIG. 2 leads to step 240, in which a maneuver “park by driving straight ahead” may be performed using the Remote Park Assist Adjust in order to park the vehicle 10 in the garage 40.

The examples shown with reference to FIGS. 3 to 8 illustrate that the automatic preselection in each case offers a user the appropriate mode for the current situation from the available “Remote Park Assist Adjust” and “Full Remote Park Assist” modes, without the user having to make a selection.

The aim of the present disclosure is therefore to create a parking assistance system which, once activated, automatically selects a mode from a number of parking assistance modes available in the parking assistance system, based on the state of the vehicle and a recognition of the environment, and makes the mode available to the user for use. Activation in this case may be effected, for example, via the vehicle's infotainment system, or remotely, for instance by means of a parking assistance app installed on a smartphone 20 or tablet. Such automation improves the user experience by reducing the number of interactive steps between the user and the parking assistance system.

The description of the disclosure is merely by way of example, and variations that do not deviate from the essence of the disclosure are to be considered to be within the scope of protection of the disclosure. Such variations are not to be considered as deviating from the concept and scope of protection of the disclosure.

1. A parking assistance system having at least two parking assistance modes for a vehicle, comprising:
state sensors for determining a state of the vehicle;
environment sensors for recognizing an environment of the vehicle, including availability and location of parking spaces relative to the vehicle; and
a control unit configured to select a first parking assistance mode from the at least two parking assistance modes based on the state of the vehicle and the environment, and presenting an offer on a mobile device to use the first selected parking assistance mode.

2. The parking assistance system according to claim 1, the state module for determining the state of the vehicle comprises sensors that sense an operating state of the vehicle.

3. The parking assistance system according to claim 1, wherein the environment module for recognizing the environment of the vehicle comprises one or more of:
at least one ultrasonic sensor,
at least one camera,
at least one radar unit, or
at least one LiDAR unit.

4. The parking assistance system according to claim 1, wherein selecting the first parking assistance mode by the control unit includes analyzing position data of the vehicle.

5. The parking assistance system according to claim 1, wherein the control unit is configures to further offer a Remote Park Assist Adjust when the vehicle is not switched on.

6. The parking assistance system according to claim 1, wherein selecting the first parking assistance mode includes analyzing locations of available parking spaces.

7. A computerized method having at least two parking assistance modes of a parking assistance system of a vehicle, wherein a processor executes instructions to perform the steps of:
determining a state of the vehicle;
recognizing an environment of the vehicle, including availability and location of parking spaces relative to the vehicle;
selecting a parking assistance mode from the at least two parking assistance modes based on the state of the vehicle and the environment; and
offering the selected parking assistance mode.

8. The computerized method according to claim 7, wherein the step of determining the state of the vehicle includes sensing the operating state of the vehicle with sensors.

9. The method according to claim 7, the step of recognizing the environment of the vehicle includes evaluating at least one of image data or radar data.

10. The method according to claim 7, further comprising the step of offering a Remote Park Assist Adjust when the vehicle is not switched on.

11. The method according to claim 7, wherein determining the state of the vehicle comprises receiving data from sensors that sense an operating state of the vehicle.

12. The method according to claim 7, wherein determining the environment of the vehicle comprises receiving data from one or more of:
at least one ultrasonic sensor,
at least one camera,
at least one radar unit, or
at least one LiDAR unit.

13. The method according to claim 1, further comprising selecting of the first parking assistance mode includes analyzing locations of available parking spaces.

14. A system that provides a parking assistance system having at least two parking assistance modes for a vehicle, the system comprising:
a control unit that comprises a processor that executes instructions to perform at least the following:
determine a state of the vehicle;
determine an environment of the vehicle based on availability and location of parking spaces relative to the vehicle;
select a first parking assistance mode from the at least two parking assistance modes based on the state of the vehicle and the environment of the vehicle; and
presenting an offer associated with the first parking sensor mode on a mobile device to a user.

15. The system according to claim 14, wherein to determine the state of the vehicle includes sensing the operating state of the vehicle with sensors.

16. The system according to claim 14, wherein to recognize the environment of the vehicle includes evaluating at least one of image data or radar data.

17. The system according to claim 14, further the control unit further includes offering a Remote Park Assist Adjust when the vehicle is not switched on.

18. The system according to claim 14, wherein determining the environment of the vehicle comprises receiving data form one or more of:
at least one ultrasonic sensor,
at least one camera,
at least one radar unit, or
at least one LiDAR unit.
